(19) United States
(12) Patent Application Publication
(10) Pub. No.: US 2015/0193128 A1
(43) Pub. Date: Jul. 9, 2015

(54) VIRTUAL DATA CENTER GRAPHICAL USER INTERFACE

(71) Applicant: Siegfried Luft, Vancouver (CA)

(72) Inventor: Siegfried Luft, Vancouver (CA)

(21) Appl. No.: 14/588,631

(22) Filed: Jan. 2, 2015

Related U.S. Application Data
(60) Provisional application No. 61/924,133, filed on Jan. 6, 2014.

(51) Int. Cl. G06F 3/0484; G06F 3/0486

(52) U.S. Cl. CPC G06F 3/04842; G06F 3/0486

(57) ABSTRACT

A data center graphical user interface. For example, one embodiment of an apparatus comprises a graphical user interface (GUI) comprising a plurality of objects selectable and editable by an end user; a virtual device controller layer comprising a plurality of virtual device controllers, each virtual device controller representing a physical data center resource and its associated configuration, the combined plurality of virtual device controllers forming a virtual data center; wherein each of a plurality of the objects of the GUI represent and map to a particular virtual device controller within a virtual device controller layer; and wherein a user may edit data center resources and the associated configuration of the data center resources by selecting the objects associated with the virtual device controllers of those resources.

### CROSS REFERENCE TO RELATED APPLICATIONS

This application claims the benefit of U.S. Provisional Application No. 61/924,133, filed Jan. 6, 2014, which is hereby incorporated by reference.

### BACKGROUND

1. Field of the Invention

This invention relates generally to the field of data processing systems. More particularly, the invention relates to a virtual data center graphical user interface.

2. Description of Related Art

Cloud computing may be provided using the models of infrastructure as a service (IaaS), platform as a service (PaaS), and software as a service (SaaS). Any of these models may be implemented within a cloud-based “data center” comprised of various computing resources (e.g., servers, routers, load balancers, switches, etc).

IaaS is the most basic model. Providers of IaaS offer physical or virtual computers (i.e., using virtual machines) and other resources such as a virtual-machine disk image library, storage resources, including file-based storage, firewalls, load balancers, IP addresses, virtual local area networks (VLANs), and software bundles. IaaS providers may supply these resources dynamically, from large pools installed in data centers. To deploy their applications, cloud users install operating system images and application software on the cloud resources. In this model, the cloud user maintains the operating systems and the application software. Cloud providers typically bill users based on the amount of resources allocated and consumed.

In the PaaS model, cloud providers deliver a complete computing platform, typically including an operating system, Web server, programming language execution environment, and database. Application developers develop and run software solutions on this cloud platform without the cost and complexity associated with buying and managing the underlying hardware and software layers. In some PaaS implementations, the underlying resources (e.g., computing, storage, etc) scale automatically to match application demand so that the cloud user does not have to allocate resources manually.

In the SaaS model, cloud providers install and maintain application software in the cloud and cloud users access the software from cloud clients (sometimes referred to as an “on-demand software” model). This eliminates the need to install and run the application on the cloud user's own computers, which simplifies maintenance and support. Cloud applications offer virtually unlimited scalability (in contrast to locally executed applications) which may be achieved by cloning tasks onto multiple virtual machines during run-time to meet changing work demand. Load balancers distribute the work over the set of virtual machines transparently to the user (who sees only a single access point).

### BRIEF DESCRIPTION OF THE DRAWINGS

A better understanding of the present invention can be obtained from the following detailed description in conjunction with the following drawings, in which:

FIG. 1A illustrates one embodiment of a cloud analysis and projection service;

FIG. 1B illustrates a graph showing details associated with the cloud provider market;

FIG. 2A illustrates a system architecture in accordance with one embodiment of the invention;

FIGS. 2B-C illustrates methods in accordance with one embodiment of the invention;

FIG. 3 illustrates a graphical example of data center arbitrage employed in one embodiment of the invention;

FIG. 4 illustrates one embodiment of a selection engine architecture;

FIGS. 5A-D illustrate additional details associated with one embodiment of a virtualization and projection component including a graphical user interface;

FIG. 6 illustrates a plurality of logical layers employed in one embodiment for projecting a virtual data center to a physical data center;

FIG. 7 illustrates additional details associated with one embodiment of a global broker;

FIG. 8 illustrates one embodiment of a virtual data center overlay;

FIGS. 9-10 illustrate one embodiment of a distributed file system engine used for migrating a data center;

FIGS. 11A-B illustrate one embodiment of a shadow storage system for migrating a data center;

FIGS. 12A-C illustrate gateways and network infrastructure employed to migrate data centers in one embodiment of the invention;

FIGS. 13A-B illustrate agents and data collection processes in accordance with one embodiment of the invention;

FIG. 14 illustrates additional details of one embodiment of a global broker and communication with selection engines.

### DETAILED DESCRIPTION OF PREFERRED EMBODIMENTS

Described below are embodiments of an apparatus, method, and machine-readable medium for cloud service selection and projection. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are not shown or are shown in a block diagram form to avoid obscuring the underlying principles of the present invention.

The embodiments of the invention described herein take advantage of the growing number of cloud service providers on behalf of those users migrating to the cloud. In particular, these embodiments include mechanisms to manage and move data centers independent of which cloud service provider is actually providing the cloud footprint. In one embodiment, the cloud footprint is an IaaS footprint; however, the underlying principles of the invention may also be implemented across data centers offering PaaS or SaaS services.

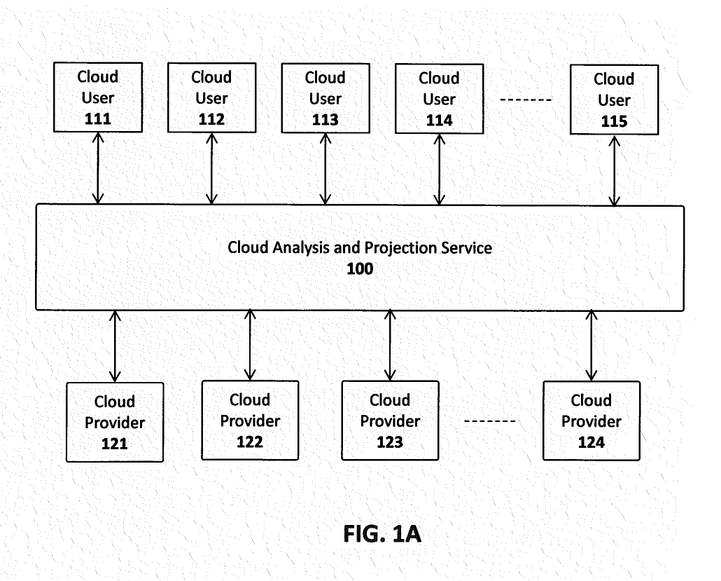

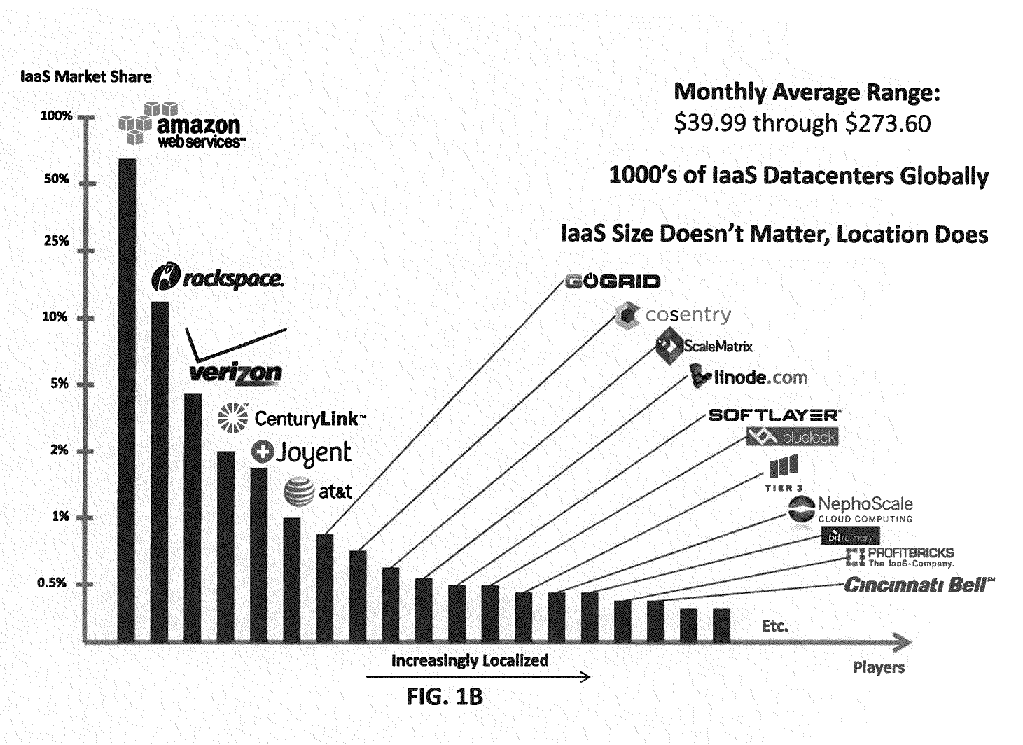

FIG. 1A illustrates a high level architecture of a cloud analysis and projection service (CAPS) 100 in accordance with one embodiment of the invention. As described in detail below, the CAPS 100 enables a number of powerful models, including the ability to arbitrage diverse datacenters offered by cloud providers 121-124 to create the optimal price, performance, availability and/or geographical reach for virtual datacenters. In particular, one embodiment of the CAPS 100 analyzes the cost data, resource data, performance data, geographical reach data, reliability data, and/or any other pertinent cloud provider variables in view of the requirements specified by cloud users 111-115. Once the relevant data has been evaluated, the CAPS 100 automatically selects one or more cloud provider on behalf of the cloud user. Alternatively, or in addition, the CAPS 100 may recommend a set of “candidate” cloud providers by performing cloud arbitrage, exploiting measurable differences between the cloud providers (e.g., striking a combination of matching deals that capitalize upon imbalances between cloud providers including the differences between cloud provider pricing, performance, service level agreements, or other measurable metrics). The end user may then select among the recommended cloud provider candidates.

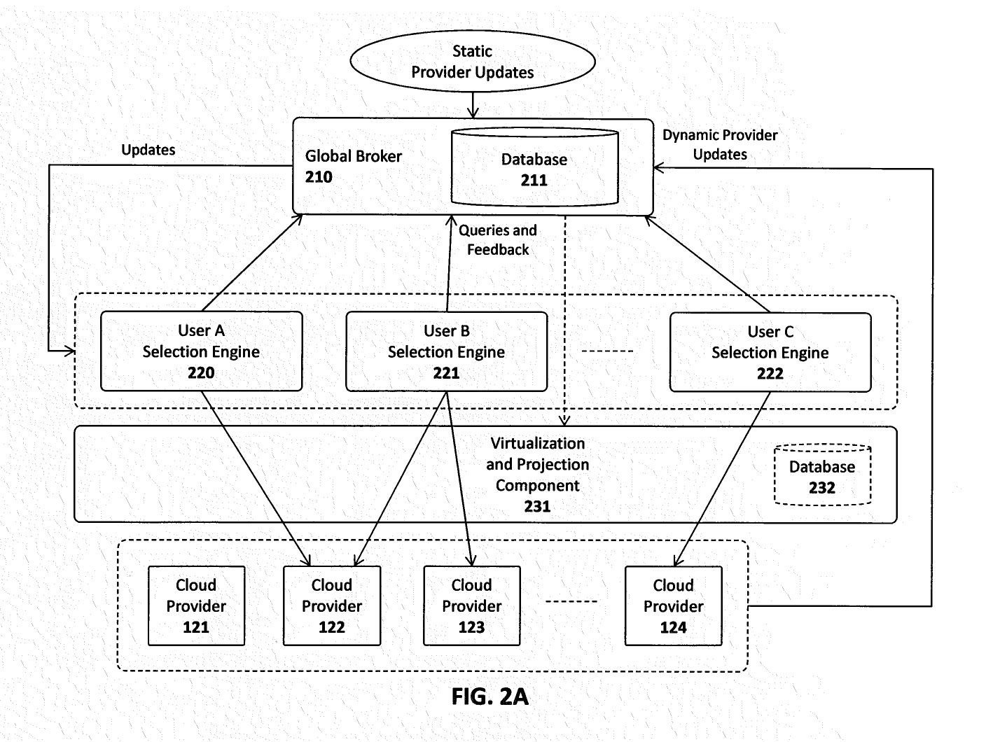

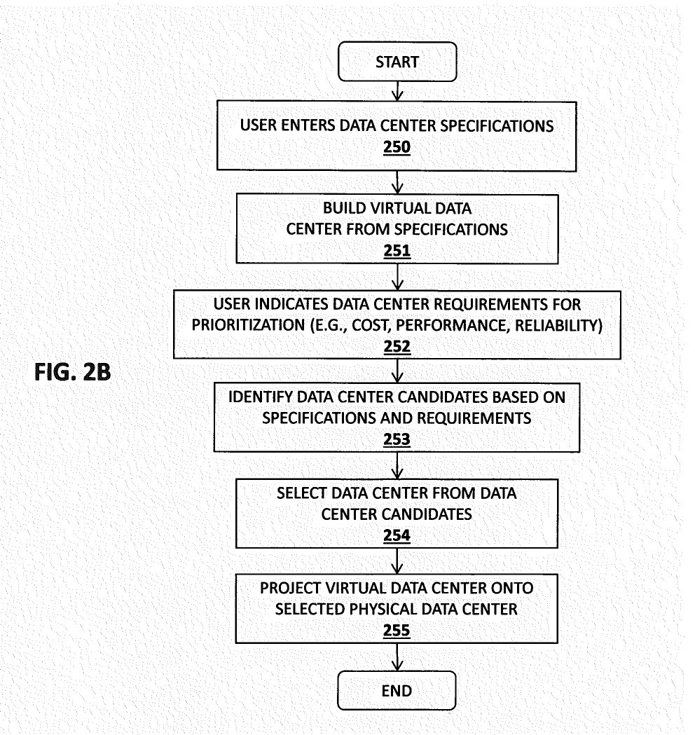

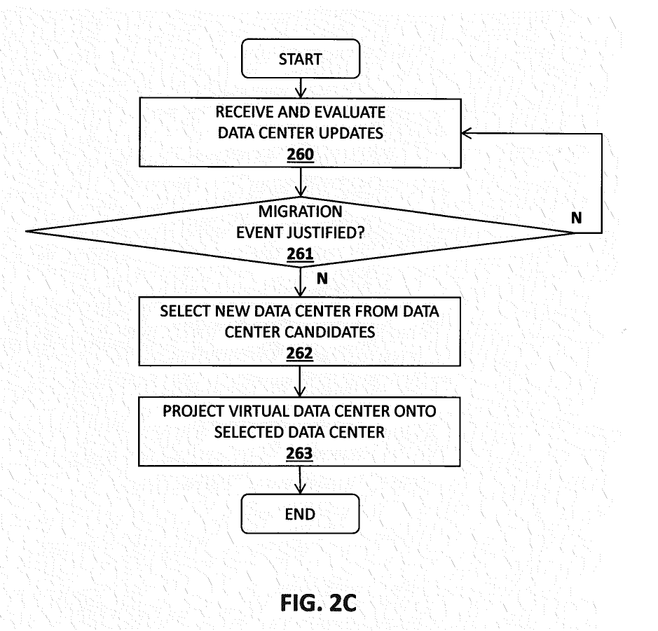

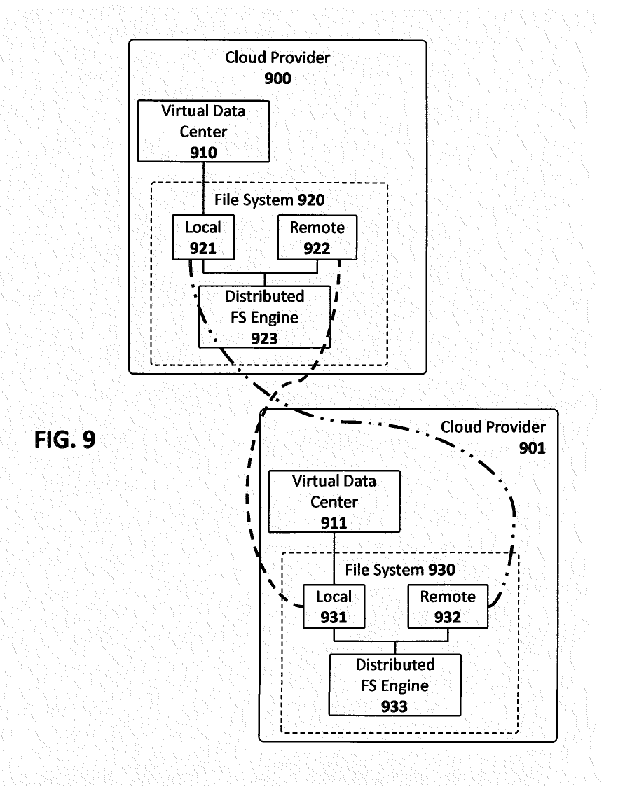

As discussed in detail below, one embodiment of the CAPS 100 includes virtualization and projection logic to virtualize data center resources and enable data center migration once a decision has been made to migrate from one cloud provider to another (see, e.g., virtualization and projection component 231 illustrated in FIG. 2A). Specifically, one embodiment of the CAPS 100 generates a virtualized or logical representation of all data center resources including (but not limited to) routers, switches, load balancers, WAN accelerators, firewalls, VPN concentrators, DNS/DHCP servers, workload/virtual machines, file systems, network attached storage systems, object storage, and backup storage, to name a few. This “virtual data center” representation reflects the atomic components that comprise the datacenter and manages the basic commissioning state of each logical device. The CAPS 100 then projects the virtual data center on the new physical data center by either translating the virtualized representation into a format necessary for implementing the physical data center, or by executing the virtual data center directly on the cloud provider (e.g., using a fully virtualized implementation such as discussed below with respect to FIG. 9).

There are thousands of small cloud service providers who are just as capable of delivering IaaS to their customers as the large providers, but are seen as fragmented or regional. Consider the chart shown in FIG. 1B that illustrates the current top North American cloud service providers. Note the logarithmic degrade of market share. By soliciting the long tail on the curve, the CAPS 100 becomes a “market maker” for aggregating data center services. In one embodiment, the CAPS 100 employs a brokerage model for buying and selling these data center services—i.e., arranges transactions between a buyer and a seller, and receives a commission when the deal is executed. This is beneficial to both cloud users 111-115 and cloud providers 121-124 because it enables movement throughout a fragmented market, and creates a conglomerated market place, without the need for outright acquisitions.

Cloud sellers 121-124 may bid into the CAPS platform 100 based on cost and other variables such as duration (a particular cost for a limit period), service level agreements, geographical location, network resources (suitability for certain distribution applications), and/or dedicated hardware resources for certain applications. This data may be further augmented with historical records from past customer transactions (e.g., using a customer feedback or other rating system). The notion of “arbitrage” is thus expanded to match the cloud buyer's requirements with a greater list of cloud seller characteristics. A simple example is price and duration. A seller may have capacity at a discounted rate but only for a specific duration (e.g., because another customer has reserved the capacity at a given point in the future). This may work for some buyers who either have more mobile datacenter architectures or only have short-term requirements for their datacenter. Overall, however, as the law of large numbers comes into effect, there will be an increased probability that the CAPS 100 can find buyers for each seller—thereby benefiting both.

As illustrated in FIG. 2A, one embodiment of the CAPS 100 includes a plurality of components including a global broker 210, a set of user selection engines 220-222 (e.g., one for each cloud user), and a virtualization and projection component 231. The global broker 210 manages a database 211 of all available cloud providers 121-124 and the attributes of the data centers offered by the cloud providers. By way of example, the database 211 may include the cost data, resource data, performance data, geographical reach data, reliability data, and/or any other pertinent information associated with the data centers operated by the cloud providers 121-124. The database 211 may be updated dynamically by the cloud providers 121-124 themselves or statically, by members of the CAPS 100. For example, if a particular cloud provider has changed the cost structure for its data center resources for a particular duration, it may update the cost/duration for this change in the database 211. Similarly, if a cloud provider has upgraded its hardware/software, or opened a new data center in a new location, it may update the database 211 to reflect the changes.

In one embodiment, the global broker 210 exposes an application programming interface (API) to enable the updates to the database 211. The cloud providers 121-124 may then utilize the API to dynamically update the database 211. This may be accomplished, for example, via CAPS software installed at each of the cloud providers 121-124 and/or via a Web server accessible by browser clients at the cloud providers. Static provider updates may also be implemented via the API.

In one embodiment, user selection engines 220-222 are executed to perform data center selections/recommendations for each cloud user. In the example shown in FIG. 2A, selection engine 220 is executed to render data center selections/recommendations for User A; selection engine 221 is executed to render data center selections/recommendations for User B; and selection engine 222 is executed to render data center selections/recommendations for User C. In operation, each selection engine 220-222 is provided with the data center requirements for a corresponding cloud user (e.g., cost, performance, reliability, geographical location, etc) and then identifies candidate cloud providers from the broker database which match those requirements.

As discussed in greater detail below, each selection engine 220-222 may generate a prioritized list of cloud providers 121-124 which match the user's requirements (e.g., with those at the top of the list being a closer match than those at the bottom of the list). The list may be provided to the end user as a set of cloud provider “recommendations” along with a comparative analysis explaining the reasoning for the recommendations. Alternatively, in one embodiment, a selection engine may automatically select one of the cloud providers on behalf of the user (and perform migrations between data centers as discussed below).

In one embodiment, the selection engines 220-222 receive updates from the global broker database 211 periodically and/or automatically to render new data center selections and/or recommendations. For example, if a particular cloud provider 121-124 has significantly reduced the cost of its services, then this may cause the selection engine to select the cloud provider and/or to place the cloud provider at the top of the prioritized list (thereby justifying a migration to the new cloud provider). The frequency with which a selection engine receives updates and generates prioritized list of data centers may vary depending on the implementation of the CAPS 100 and/or the preferences of each cloud user.

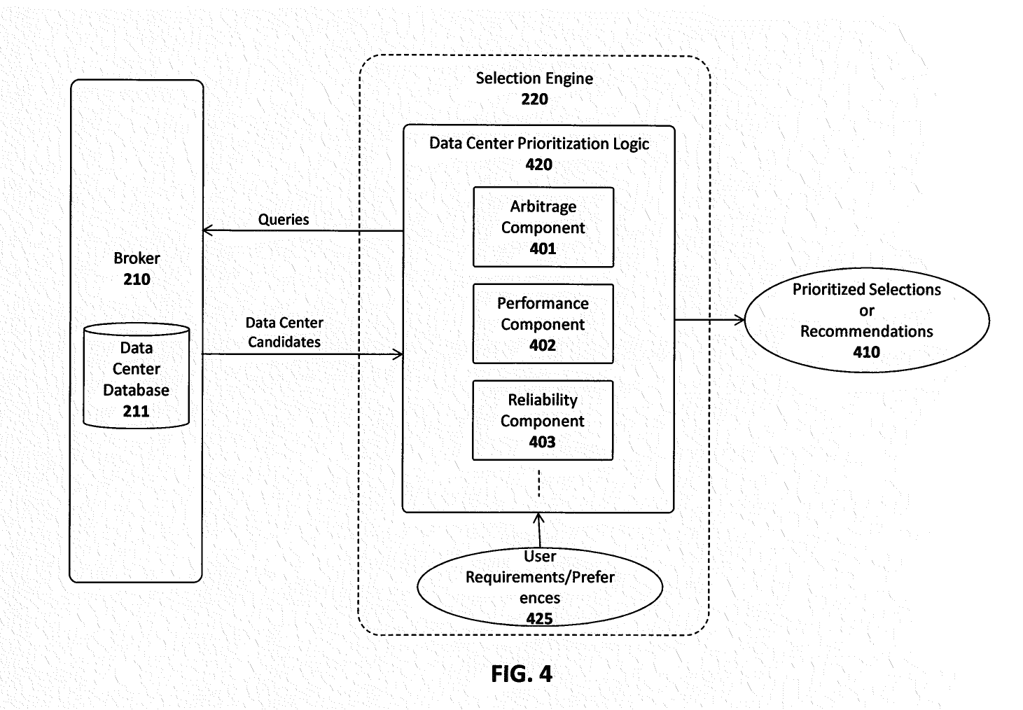

FIG. 4 illustrates additional details associated with a selection engine 220 including data center prioritization logic 420 for sending queries to the broker 210 indicating data center requirements (e.g., as specified by user requirements/preferences 425). For example, based on user input 425, the data center prioritization logic 420 may send a query specifying that it is only interested in data centers within a specific geographic region and having certain capabilities (e.g., load balancing, automatic failover capabilities, etc). As a result, the data center candidates provided by the broker 210 will be limited to those with the required parameters.

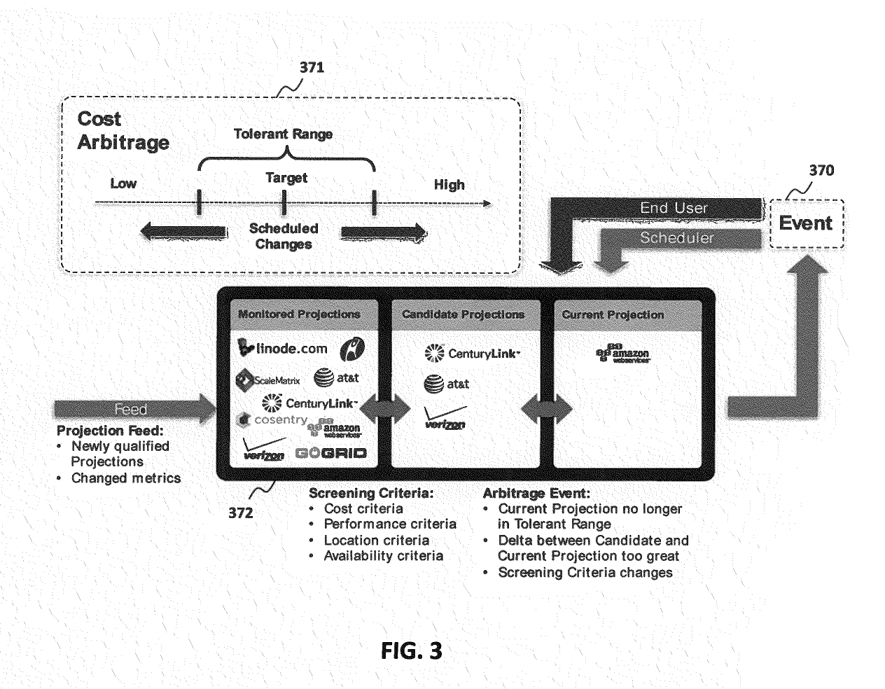

As indicated in FIG. 4, the data center prioritization logic 420 may then prioritize the data center candidates based on various weighted components including an arbitrage component 401, a performance component 402 and a reliability component 403. While only three components are shown in FIG. 3, various other/additional components may be included in the data center prioritization logic 420 while still complying with the underlying principles of the invention (e.g., such as geographical location, data center ratings from end users, etc).

In one embodiment, weights are assigned to each component 401-403 based on the user-specified requirements/preferences 425. For example, if a particular cloud user is primarily interested in low cost data center services, then the arbitrage component 401 may be weighted more heavily than the performance component 402 and the availability component 403. Another cloud user may also be interested in low cost but may specify minimum performance 402 and/or reliability 403 requirements. In such a case, the data center prioritization logic 420 will filter out those data centers which do not meet the minimum requirements and will then prioritize the remaining data center candidates based on cost. Yet another cloud user may be primarily concerned with data center reliability 403 and, as a result, the reliability component 403 may be weighted more heavily than the arbitrage 401 or performance 402 components. Various different/additional algorithms may be implemented by the data center prioritization logic 420 to generate the prioritized selections or recommendations 410 based on relative component weights.

Returning to FIG. 2A, once a new cloud provider has been selected, the virtualization and projection component 231 manages the migration of the data center to the new cloud provider. As mentioned above, one embodiment of the virtualization and projection component 231 maintains a “virtual data center” representation of data center resources required by each cloud user such as routers, switches, load balancers, WAN accelerators, firewalls, VPN concentrators, DNS/DHCP servers, workload/virtual machines, file systems, network attached storage systems, object storage, and backup storage, to name a few. This “virtual data center” representation reflects the atomic components that comprise the datacenter and manages the basic commissioning state of each logical device (e.g., the user-specific configuration for each device). In one embodiment, the virtualization and projection component 231 maintains its own database 232 of all of the necessary data for managing/migrating each virtual data center. Alternatively, the virtualization and projection component 231 may rely on the global broker database 211 to store this data.

Once the new data center is selected, the virtualization and projection component 231 projects the virtual data center on the new data center. As mentioned, the projection to the new data center may involve translating the virtualized representation into a format necessary for implementing the physical data center (e.g., based on the specific hardware/software resources of the cloud provider) or by executing the virtual data center directly on the cloud provider (e.g., using a fully virtualized implementation such as discussed below with respect to FIG. 9). Once the projection is complete, the old data center may be taken offline.

FIG. 2B illustrates one embodiment of a method for selecting a new data center based on user-specified data center specifications and requirements and FIG. 2C illustrates one embodiment of a method for migrating from one data center to another.

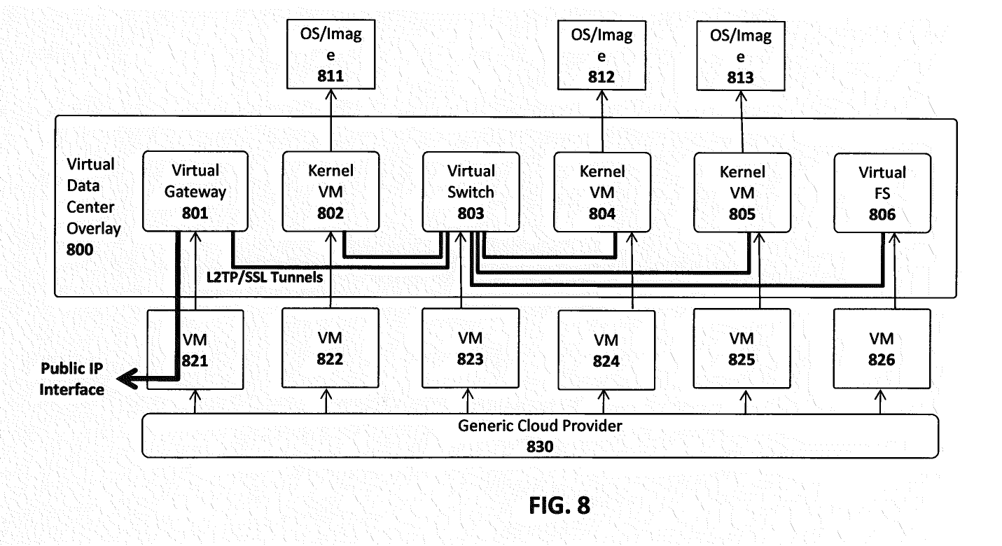

Turning first to FIG. 2B, at 250, the user enters the specifications for the data center. As used herein, the “specifications” comprise the particular components and architecture of the data center including, for example, the arrangements of routers, switches, load balancers, WAN accelerators, firewalls, VPN concentrators, DNS/DHCP servers, workload/virtual machines, file systems, network attached storage systems, object storage, and backup storage. In one embodiment, the virtualization and projection component 231 may provide the user with a graphical user interface (GUI) for graphically selecting the data center components and the interconnections between components (see, e.g., FIG. 8 and associated text). The GUI may be Web-based (e.g., provided via Web pages accessible via a browser) or may be implemented as a stand-alone application. In one embodiment, the virtualization and projection component 231 determines the data center specifications by asking the cloud user a series of questions related to the data center architecture. Alternatively, or in addition, the virtualization and projection component 231 may provide the user with a set of pre-constructed data center templates from which to select based on the user's data center requirements. Each of the templates may be associated with a certain set of required resources and/or have particular parameters associated therewith.

Regardless of how the user enters the data center specifications, at 251, the virtualization and projection component builds the virtual data center representation using the specifications. As discussed above, in one embodiment, the virtual representation comprises an abstract representation of all required data center resources and architectural layout (e.g., interconnections between the resources). The virtual representation reflects the atomic components that comprise the datacenter and manages the basic commissioning state of each logical device.

At 252, the user indicates the various factors to be considered for prioritizing data center candidates. As discussed above, this may involve associating weights with variables such as data center cost, performance, and/or reliability a data based on the user's preferences/requirements. At 253, a set of data center candidates are identified based on the specifications and requirements. For example, as previously discussed, if a particular cloud user is primarily interested in low cost data center services, then the cost variable may be weighted more heavily than the performance and the availability variables. Various different prioritization algorithms may be implemented to generate the prioritized selections or recommendations based on relative component weights.

At 254, a data center is selected from the identified data center candidates. In one embodiment, the selection is performed by the cloud user (e.g., after reviewing the prioritized list of candidates). In another embodiment, the selection is performed automatically on behalf of the cloud user.

Regardless of how the data center is selected, at 255, the virtual data center is projected onto the selected physical data center. As mentioned, the projection to the new data center may involve translating the virtualized representation into a format necessary for implementing the physical data center (e.g., based on the specific hardware/software resources of the cloud provider) or by executing the virtual data center directly on the cloud provider (e.g., using a fully virtualized implementation such as discussed below with respect to FIG. 9). Once the projection is complete, the data center may be placed online.

FIG. 2C illustrates one embodiment of a method in which an existing data center is migrated to a new data center. At 260 data center updates are received and evaluated and, at 261, a determination is made as to whether migration to a new data center is justified (e.g., based on price, performance and/or reliability considerations). As mentioned, the global broker 210 may receive continuous dynamic updates from cloud providers 121-124 and/or may be updated statically (i.e., by members of the CAPS 100). As these updates are stored in the global broker 210, each selection engine 220-222 may execute its selection policy to determine whether migrating to a new data center would benefit the end user. For example, the decision to migrate may be based on changes to the current data center and/or the other candidate data centers (e.g., changes to cost, SLA, tier of datacenter in addition to cost, time of day, performance for limited periods of time, availability, etc).

A graphical depiction of one embodiment of the decision-making process for selecting a new data center is illustrated in FIG. 3. As illustrated, a migration event 370 may be generated upon detecting that the cost associated with the current data center has moved outside of a tolerant range (e.g., as indicated in cost arbitrage box 371). The event may be a scheduled event (e.g., the cloud provider may provide advance notice of the cost change), in which case, the selection engine may employ a scheduler to trigger a migration event to move the data center at a particular point in time (e.g., the point at which the cost is anticipated to rise above the target range). As indicated in box 372, the global broker may be continually updated via a projection feed with data related to all monitored data centers. The set of all monitored data centers are filtered by the selection engines based on screening criteria such as cost, performance, location, and/or availability to arrive at a set of candidate data center projections. One particular data center is then selected from the set of candidates based on an “event” such as the current projection failing to fall within the tolerant range, the difference between a candidate and a current projection rising above a threshold, and/or changes to the screening criteria. The end result is that an event is triggered (either automatically or manually by the cloud user) to migrate the data center.

Returning to FIG. 2C, at 262, the new data center is selected from the set of candidates and, at 263, the virtual data center is projected onto the newly selected data center (e.g., using the various projection techniques described herein).

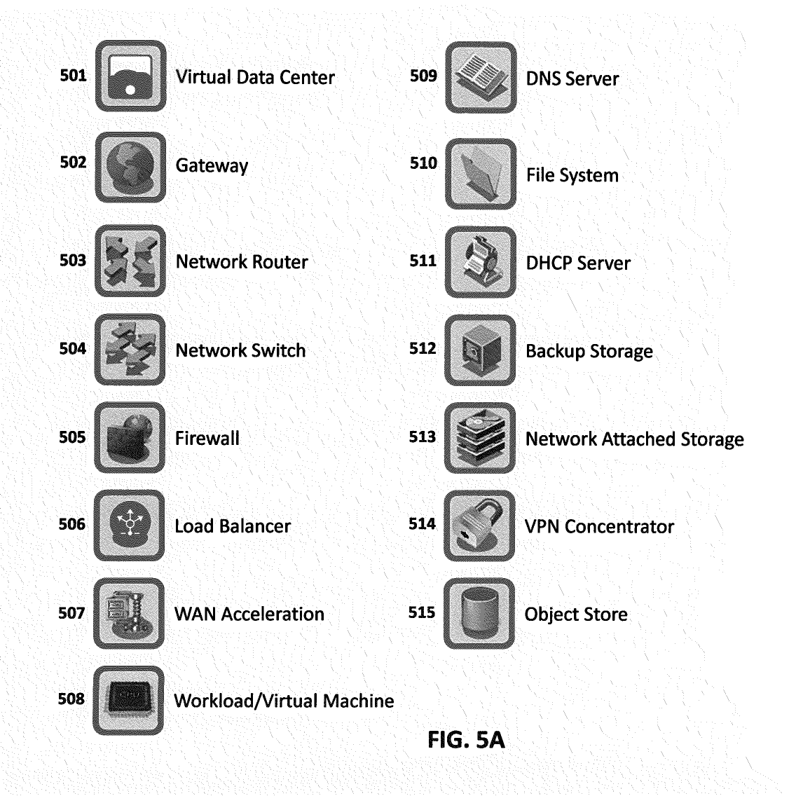

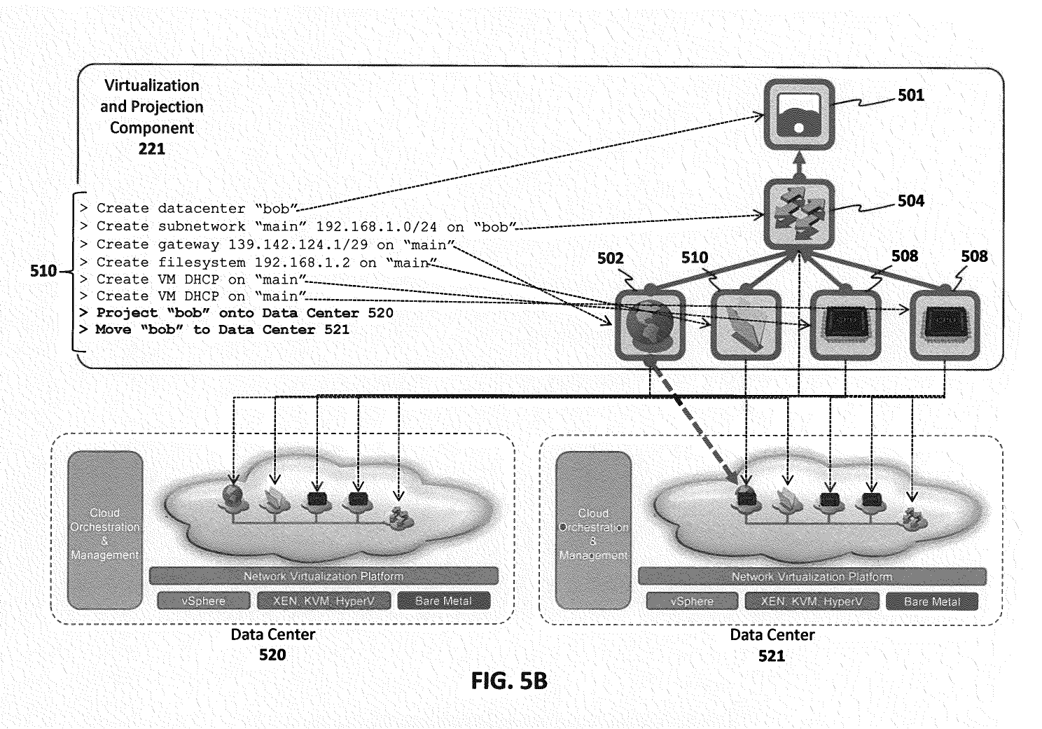

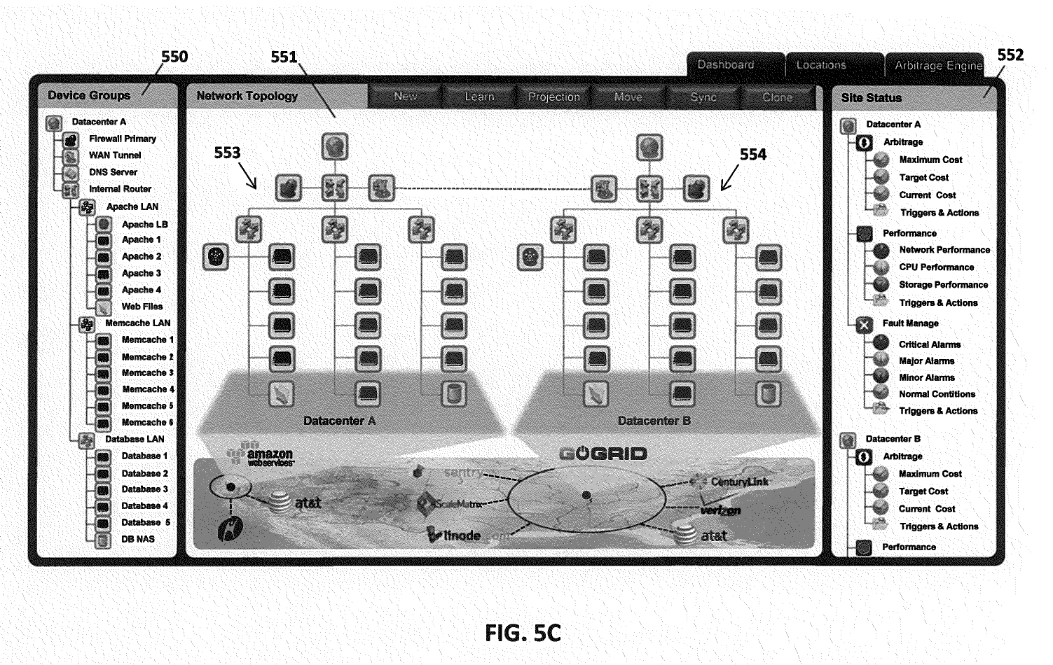

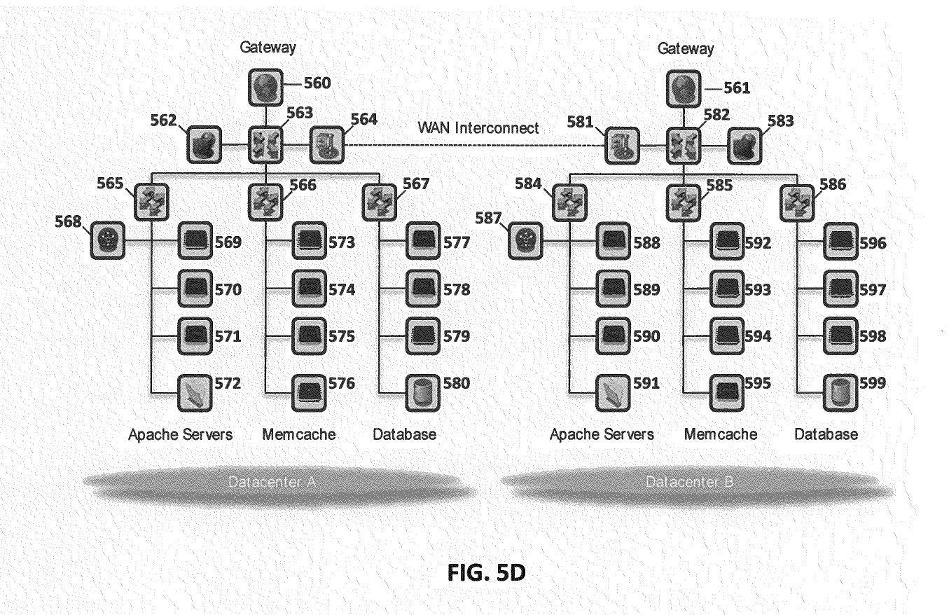

As illustrated in FIGS. 5A-D, one embodiment includes a graphical user interface and a command line interface for creating and managing the virtual data center. In one embodiment, each of the virtual controllers employed in the virtual data center are represented by unique graphics. FIG. 5A illustrates one particular set of graphics to represent virtual controllers including a virtual data center graphic 501; a gateway graphic 502; a network router graphic 503; a network switch graphic 504; a firewall graphic 505; a load balancer graphic 506; a WAN acceleration graphic 507; a workload/virtual machine graphic 508; a DNS server graphic 509; a file system graphic 510; a DHCP server graphic 511; a backup storage graphic 512; a network attached storage graphic 513; a VPN concentrator graphic 514; and an object store graphic 515.

A brief description of each of the virtual controllers represented by these graphic images is set forth below. In one embodiment, access to the underlying resources is provided via a management interface exposed by the virtualization and projection component 221.

The Virtual Datacenter 501 is a process that captures high level attributes of the projection such as geographical location, SLA, tier, etc. This is a non-operational object that is used to group geographic disparate datacenters at a top level view. The attributes of the virtual data center may include location, service level agreement, data center tier, pricing category.

The Gateway Router 502 is responsible for the public routes over the Internet. The attributes include WAN Configuration, Route Entries, Route Protocols, Interface monitoring, DNS Properties, Topology/Routing Information, and Affinity Rules.

The network router 503 is responsible for routing between all subnetworks within the virtual datacenter. Multiple network routers may be instantiated with different interfaces tied to different subnetworks, much like a real router. The attributes may include Network Configuration, Route entries, Route protocols, Interface monitoring, and Affinity rules.

The network switch 504 embodies the notion of a subnetwork. Interfaces connecting different devices to each other within a subnetwork are modeled by this entity. In cases where telemetry for each connected device is collected, the network switch can be the managed entity to identify the usage and therefore cost and performance of the datacenter. The attributes may include Network Configuration, Monitoring, and Affinity Rules.

The firewall 505 is a feature that typically is provided by the cloud provider, but could be an additive feature offered by the CAPS 100 (either directly or through an App Store concept). The Firewall can provide a range of potential offerings including, but not limited to network address translation (NAT), distributed denial of service (DDOS) protection, and flow monitoring. Attributes may include Network configuration, Firewall Policies, Monitoring Policies, and Affinity Rules.

The load balancer 506 is a device used to map a number of identical workloads together for scale out purposes. The attributes may include Network configuration, Addressable End Stations, Balancing Policies, Monitoring, and Affinity Rules.

The WAN accelerator 507 is a service available for interconnecting datacenters over the WAN. This element may include devices such as Riverbed which offers deduplication compression algorithms. These services may be offered by cloud providers as a virtual workload to cloud users. Between two or more virtual datacenters, an instance of a WAN accelerator may be employed (one at each site) to compress data heading across the WAN. Attributes may include Network Configuration, End-Point-Configuration, SLA, Base User Privileges, Monitoring, and Affinity Rules.

The Workload/Virtual Machine 508 maintains the generic configuration of the OS image. It is responsible for transposing these images for a variety of VM formats such as VMDK, ISO, etc. By maintaining these images at all times, the migration process is greatly streamlined. The attributes may include CPU Class and Quantity, Memory, Local Storage, Operating System Image, Network Configuration, and Affinity Rules.

The DNS Server 509 provides a method for the virtual datacenter to offer naming both internal and external to the IaaS Datacenter. It should tie into both the naming services of the hosting IaaS service provider and the Siaras Global Directory/Broker. The attributes may include Domain Names, Addressing, Migration Features, Monitoring, and Affinity Rules.

The File System 510 may be associated with network attached storage (NAS). It may be a shared resource but can have some associated privileges, either through addressability or potentially user-based privileges. A core feature of the migration component of the file system includes the migration of data. In one embodiment, the virtual controller supports the ability to transfer data from one file system instance to another. Migration may be orchestrated at a higher layer than the virtual file system controller, but the controller should offer at minimum a “Sink” and “Source” mechanism for the transfer. As discussed in greater detail below, in one embodiment, a distributed file system (e.g., such as Hadoop) is employed that does not require the manual transfer of data. Each instance of the file system automatically binds to the existing nodes and downloads the necessary local data. The attributes of the file system may include Size, Network Configuration, SLA, Base User Privileges, Backup Policies, and Affinity Rules.

The DHCP Server 511 allows the datacenter provider to define addressing schemes and ACLs, and other controls over devices within the logical datacenter. The attributes may include Sub-Network Configuration, Monitoring, and Affinity Rules.

Backup storage 512 is a core attribute of any High Availability application and may be attributed features of the local IaaS service provider, or possibly a value add feature of the CAPS. In the later case, at issue would be the amount of data transferred out of physical datacenters, and the cost associated with them.

Network Attached Storage 513 may be a high performance storage methodology that can be available in Tier 1 IaaS Cloud datacenters or within private datacenters. These controllers are used to manage these resources. The attributes may include LUNs & Size, RAID Policies, Network Configuration, SLA, Base User Privileges, Backup Policies, and Affinity Rules.

The VPN concentrator 514 is the end station that remote clients will use to connect to the datacenter. VDI applications and other basic secure connectivity would utilize a VPN concentrator or act as a simple secure VPN end point. Attributes may include Network configuration, Firewall Policies, Monitoring Policies, and Affinity Rules.

IaaS Cloud providers may offer object storage capabilities, represented by object store graphic 515. Optimally, the object store virtual controllers will offer a transformation function to map one object storage facility to another. It may be the responsibility of the end applications to utilize Cloud PaaS abstraction solutions, such as Chef or Cloud Foundry to deal with the API changes. In one embodiment, the CAPS' role is to ensure the move is done effectively, and the data is available for the new project to continue processing. The attributes may include Size, Network Configuration, SLA, Base User Privileges, Backup Policies, and Affinity Rules.

FIG. 5B illustrates an exemplary series of commands 510 which may be executed by the virtualization and projection component 221 (e.g., via a command line accessible to the exposed management interface) to build a virtual data center. While a command line interface is illustrated for the purposes of explanation, the same set of commands may be executed in response to a user manipulating elements within a graphical user interface (e.g., as shown in FIGS. 5C-D). In this example, a “create datacenter ‘Bob’” command creates a virtual controller for a datacenter named “Bob’ represented by graphic 501. The command “create subnetwork ‘main’ 192.168.1.0/24 on ‘bob’” creates a network switch virtual controller 504 under the virtual data center “Bob” and the additional set of “create” commands create a gateway virtual controller 502, file system virtual controller 510, and two virtual machine virtual controllers 508 under the network switch 504. The resulting virtual data center is then projected to data center 520 via the “Project” command. As described herein, various different techniques may be employed for projecting the virtual data center to a physical data center. After the virtual data center has been successfully projected, a “Move” command may be executed to migrate the virtual data center to a new physical data center 521.

FIG. 5C illustrates an exemplary graphical user interface (GUI) “dashboard” for creating and managing virtual data centers. The network topologies for two datacenters, datacenter A 553 and datacenter B 554, coupled together via a WAN accelerator are illustrated within a GUI window 551. In one embodiment, the user may create, edit, and delete the virtual controllers within the displayed network topology by selecting and dragging the graphical elements representing the virtual controllers. For example, virtual controller elements displayed within region 550 of the GUI may be selected and the configuration data associated with each of the elements may be edited. Alternatively, the user may directly select a virtual controller from the GUI window 551 to edit the variables associated with the controller.

A site status window 552 is also illustrated to provide data related to arbitrage (i.e., data center cost), performance, and reliability. Under the graphical arbitrage element, the user may access various cost information including a maximum specified cost, a target cost, and a current cost associated with the usage of each data center. In addition, under the graphical arbitrage element, the user may specify triggers and actions in response to changes in cost values (referred to in FIG. 2D as “events”). For example, the user may specify that a migration should occur if the cost value rises above a particular threshold.

Under the graphical performance element, the user may review current performance measurements including network performance, CPU performance, and storage performance. The user may also may specify triggers and actions in response to changes in performance values. For example, the user may specify that the data center should be migrated if performance of any particular variable drops below a specified threshold.

Under the graphical fault management element, the user may access various fault/reliability data including different types of system alarms (e.g., critical alarms, major alarms, minor alarms, etc). Once again, the user may specify triggers and actions in response to changes in reliability. For example, the user may specify that the data center should be migrated if the number of critical or major alarms rises above a specified threshold.

In one embodiment, the management GUI shown in FIG. 5C provides the following functions/features:

the distributed datacenters should be visible over their respective geographies;

the active projects show which IaaS service provider is offering service;

the ability to define policies under which the virtual datacenters should be projected, including policies based on Location, Cost, Time, Performance, SLA, Tier, Replication;

the alternative datacenters (monitored sites) should be visible to the end user;

the ability to clearly see where issues exist including performance issues, cost issues, and availability issues (e.g. an IaaS provider who is offering limited times for their assets, might have a count down timer)

the ability to plan moves ahead of time, and perhaps monitor that resources remain available at the destination location;

the ability to clearly see where costs are within different datacenter instances, and where the costs are within a given datacenter (e.g., an hourly reporting mechanism may be maintained to facility financial forensics at the end of a month, quarter, or year); and/or

the ability to configure policies around a datacenter move. This may include alarm notifications requiring manual intervention, and the ability to schedule migrations based on predetermined maintenance windows (e.g. if an arbitrage event occurs, move at 2 am the next morning). A special case might be that if an existing projection dies due to a failure within the datacenter, then move immediately.

FIG. 5D illustrates the hierarchical virtual controller arrangement shown in window 551 in greater detail. As mentioned, the user may design a virtual data center simply by selecting and dragging the graphical elements representing each of the virtual controllers 560-599. In the particular topology shown in FIG. 5D, a gateway 560 is associated with Datacenter A and gateway 561 is associated with Datacenter B. A network router 563, firewall 562, and WAN accelerator 564 are logically positioned directly under gateway 560 and another network router 582, firewall 583, and WAN accelerator 581 are positioned directly under gateway 561 in the hierarchical arrangement. As illustrated, a dedicated WAN interconnect communicatively coupling the two WAN accelerators, 564 and 581 may be used to ensure redundancy and/or failover between the two data centers. In one embodiment, as discussed below, the WAN interconnect may be used to streamline the migration process (i.e., when migrating a virtual datacenter to a new physical datacenter).

A first set of network switches 565-567 are logically positioned beneath the network router 563 of Datacenter A and a second set of network switches 584-586 are logically positioned beneath the network router 582 of Datacenter B. Switch 565 couples a set of Apache servers to the local network comprised of a load balancer 568, a set of workload/VM units 569-571 (for executing processing tasks), and a file system 572. Switch 566 couples a second set of workload/VM units 573-576 for implementing a memory cache subsystem (“Memcache”) and switch 567 couples another set of workload/VM units 577-579 and an object store 580 for implementing a database.

In the example shown in FIG. 5D, a mirrored set of components is configured in Datacenter B. For example, switch 584 couples a set of Apache servers to the local network comprised of a load balancer 587, a set of workload/VM units 588-590 (for executing processing tasks), and a file system 591. Switch 585 couples a second set of workload/VM units 592-595 for implementing a memory cache subsystem (“Memcache”) and switch 586 couples another set of workload/VM units 596-598 and an object store 599 for implementing a database.

In one embodiment, additional data center elements such as processing, networking, and storage resources may be added simply by clicking and dragging virtual controllers within the illustrated hierarchical architecture. For example, additional workload/VM controllers may be added under each respective switch to increase processing capabilities. Similarly, additional switches may be added under the routers 563, 582 to add new subsystems to the datacenter topology.

In some of the embodiments described below, the file systems 572 and 591 are distributed file systems which have built in capabilities for maintaining synchronization between the two datacenters across the WAN interconnect (e.g., such as Hadoop).

As a specific example using the architecture shown in FIG. 5D, web services may be offered by the groups of Apache servers load balanced by load balancing appliances 568, 587. These may be within a single subnetwork. The Memcache servers may form a second subnetwork to maintain active caches of their respective databases. The group of database servers 577-579, 596-598 each operate from a common data store 580, 599.

In operation, when a URL request enters the datacenter through the Gateway 560, 561, it is screened by the Firewall 562, 583, and then forwarded to the Load Balancer 568, 587 which redirects the request to one of the Apache servers. In a heavily loaded condition, the number of servers may be automatically spun up in this case. For example, ranges of servers may be defined, and triggers may be used to expand and contract those server pools. What is unique here is that the illustrated architecture is an actual logical datacenter that is orthogonal to any given cloud provider offering—thus making it inherently portable.

Returning to the above example, once the URL is processed, the active Apache server will forward the request to the Memcache servers. If there is a dirty bit in the Memcache (e.g. data is out of date), in one embodiment, the Memcache will respond right away (e.g., within 200 ms), with out-of-date data, rather than waiting multiple seconds for a refresh. When the event occurs, the Memcache will trigger a database query from the next bank of servers. In doing so, when the end user clicks refresh on their browser, they typically get the up-to-date data. In other words, leaving it to the end user to re-request data, gives the Memcache the necessary time to update “behind the scenes.”

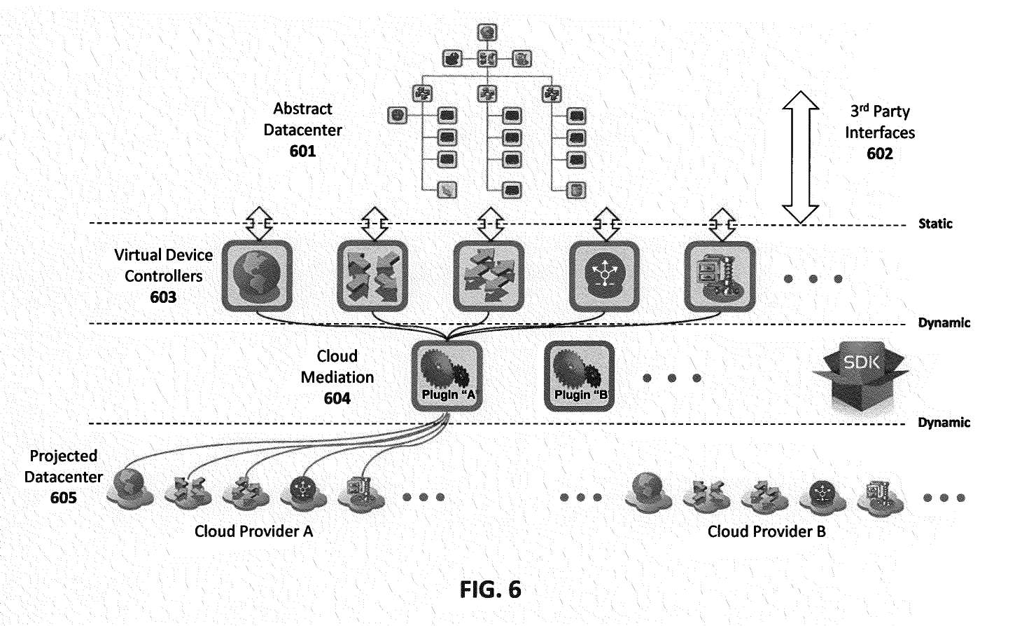

FIG. 6 illustrates various layers which are used in one embodiment of the virtualization and projection logic 221 to project a virtual data center to a cloud provider. In particular, an abstract, virtual datacenter representation 601 may be built using the GUIs shown in FIGS. 5A-D and/or via a third party user interface 602 (e.g., using a GUI designed by a third party). In one embodiment, each object from the abstract GUI layer 601 (e.g., such as the graphical objects 560-599 shown in FIG. 5D) maps to a particular controller within the virtual device controller layer 603. Each virtual device controller comprises a virtual data structure containing the data required to implement the underlying piece of hardware (e.g., a router, switch, gateway, etc) as well as an interface to provide access to the data. For example, the interface may be implemented using representation state transfer (REST) or any other interface model.

The resulting set of virtual device controllers 603 may be mapped to corresponding physical devices within the projected datacenter 605 via a cloud mediation layer 604, which may be implemented using a Cloud API (e.g., JClouds). In one embodiment, a separate “plugin” module is provided to map and/or translate the virtual device controller representation into a format capable of being implemented on the resources provided by the cloud provider. Consequently, in FIG. 6, Plugin A is used to map and/or translate the virtual datacenter representation to Cloud Provider A and Plugin B may be used to translate and project the virtual datacenter representation to Cloud Provider B. Thus, when a new datacenter registers its services with the broker 210, the underlying virtual datacenter representation does not need to be modified. Rather, only a new plugin is required to map and/or translate the existing virtual datacenter to the new physical datacenter. The plugins may be implemented on a server within the cloud provider premises (e.g., on the cloud provider LAN) and/or at the CAPS 100.

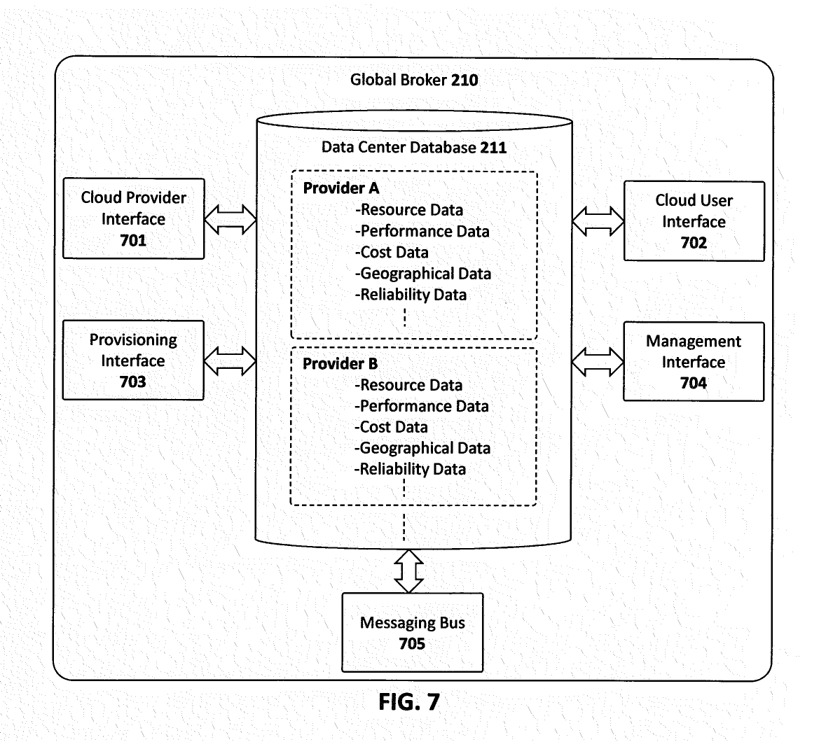

Additional details associated with one embodiment of a global broker 210 are illustrated in FIG. 7. As previously described, the global broker 210 includes a data center database 211 containing data related to each provider including, but not limited to, resource data (e.g., specifying the types of processing, networking, and storage platforms available), performance data (e.g., measured based on latency associated with processing tasks or network communication tasks), cost (e.g., in dollars per day or other unit of usage), geographical data (e.g., indicating geographical locations), and reliability date (e.g., based on the average number of significant alarms over a particular period of time).

In one embodiment, various application programming interfaces (API) are exposed to provide access the data center database 211 including a cloud provider interface 701, a cloud user interface 702, a provisioning interface 703, and a management interface 704. In one embodiment, each interface includes a set of commands to perform operations on the database (e.g., to create records, delete records, modify records, etc.). Cloud providers are provided with access to the data center database 211 via the cloud provider interface 701, cloud users are provided with access via the cloud user interface 702, database provisioning is performed via the provisioning interface 703, and management operations are provided via the management interface 704. In addition, a messaging bus 705 is provided which allows all cloud users to maintain up-to-date views of available resources (e.g., by providing data center results to a queue to which the cloud users listen as discussed below).

In one embodiment, the management interface 704 is used by the CAPS 100 to perform any and all house keeping functionality required for the sustained execution of the system. Functions that may be supported by the management interface include the ability to:

view and modify data related to active Buyers and Sellers;

provide access control lists (ACLs) that limit the accessibility of Buyers and Sellers;

monitor the throughput of the message bus 705;

spin up or down additional computational and storage elements to handle different loads;

manage SaaS-based datacenter manager clients;

drop into low-level command line debug and diagnostics tools;

shut down the system and prepare for a move to a new data center;

see all running instances of the system, including those running in multiple datacenters;

manage failover solutions; and/or

statically manage customers for debugging purposes.

In one embodiment, the provisioning interface 703 allows the CAPS 100 to provide updates to the data center database 211 (e.g., adding new entries for vetted datacenters and/or partner datacenters and removing data centers which are no longer in service or undesirable). In the non-partner category (e.g. IaaS providers that are not actively aware that the CAPS 100 utilizing their resources), it is up to the CAPS 100 to provide updates to the data center database 211 as changes occur.

In one embodiment, configuration techniques such as data center “Zones” (as used by Amazon) are not made transparent to cloud users. For example, Zones may simply be identified as different datacenters. Consequently, one virtual datacenter may be employed in a Zone of a cloud provider (e.g., Amazon), and one virtual datacenter may be employed in a different cloud provider (e.g., Rackspace). A corollary to this is that cloud users may be allowed to specify that they wish to have a single provider, but different sites/zones (e.g., using affinity rules indicating affinity for certain sites).

In one embodiment, the functions included by the provisioning interface 703 include the ability to:
add/remove/view IaaS Datacenter (Seller) records;

update static/dynamic Seller records;

force a push of records to Buyers;

create a new Buyer and optionally the associated SaaS infrastructure (using Siaras template); and/or

view statistics and reports relating to registered Buyers and Sellers

In one embodiment, the cloud provider interface 701 is open to cloud providers wishing to post details of their available services. The API may be tied to a SaaS Web Portal for manual entry and open for M2M integration with automated systems. The functions of this interface may include the ability to add/remove/view/update cloud provider records.

In one embodiment, the cloud user management interface 704 is open to cloud users running managed virtual datacenters. These systems may either be running in clouds themselves (as an SaaS) or as an enterprise application. The purpose of this interface is to provide a methodology for the managed virtual datacenters to report on their current execution experiences. The interface may be implemented as a closed system that is activated only through the management software provided to cloud users by the CAPS 100 (i.e., customers do not have direct access to this interface). In one embodiment, the functions included in the cloud user interface include the ability to:

report updates to the observed performance of a virtual datacenter;

report any outages observed by specific service provider;

report any failures to configure within virtual datacenter (e.g. incompatibilities between our mediation systems, or lack of reported capabilities or available resources); and/or

provide a customer satisfaction reporting methodology and trouble ticket mechanism.

In one embodiment, the global broker is responsible for redirecting DNS entries for cloud users. In doing so, migration of datacenters may be instantly updated. In addition, one embodiment of the global broker 210 is designed to support scale. In particular, any interface requiring multiple clients supports scale out architectures.

As mentioned above, the virtualization and projection component 221 may project the virtual data center on a physical data center by either translating the virtualized representation into a format necessary for implementing the physical data center (i.e., a plugin which converts the abstract data into a format usable by the data center's physical resources), or by executing the virtual data center directly on the cloud provider.

FIG. 8 illustrates the latter scenario which utilizes a fully virtualized implementation comprising a virtual data center overlay 800 running on a plurality of virtual machines 821-826 provided by a generic cloud provider 830. Thus, this embodiment comprises a fully re-virtualized cloud layer in which each component 801-806 of the virtual datacenter 800 may be projected on any cloud provider—from the most generic to the most sophisticated. In the specific example shown in FIG. 8, each component runs on a different VM exposed by the generic cloud provider 830. In particular, the virtual gateway 801 runs on VM 821. Three different Kernel VMs 802, 804, and 805 comprising virtual kernels run on VMs 822, 824, and 825, respectively. As illustrated, operating systems or other software images 811, 812, and 813 may be executed on top of the kernel VMs 802, 804, and 805, respectively. A virtual switch 803 runs on VM 823 and a virtual file system 806 runs on VM 826.

As indicated in FIG. 8, each of the virtual components 801-806 forming the virtual data center 800 may communicate using the Layer 2 Tunneling Protocol (L2TP) tunnels, Secure Sockets Layer (SSL) tunnels, or another secure inter-process protocol to create secure tunnels between components. In addition, as illustrated, the virtual gateway 801 communicatively couples the other components 802-806 to a public network via a public IP interface provided via VM 821.

There are several benefits to utilizing a virtual data center overlay. First, because no translation is required, the virtual data center overlay may be deployed seamlessly on any physical data center capable of providing a consistent VM. A more homogenous SLA and security profile may be imposed over various tiers of datacenter services. In addition, far greater control and visibility of the actual datacenter may be provided, resulting in a more homogenous offering over time. For example, agents could be included in every entity (e.g. vGateway, KVM, vSwitch, vFileSystem, etc), to continuously measure performance and cost.

As mentioned above, the file systems 510, 572, 591 implemented in one embodiment of the invention are distributed file systems which have built-in capabilities for maintaining synchronization between the two (or more) datacenters across a WAN interconnect. FIG. 9 illustrates one such embodiment which includes a first virtual data center 910 utilizing a file system 920 on cloud provider 900 and a second virtual data venter 911 utilizing an associated file system 930 on cloud provider 901. Each of the file systems, 920 and 930, include distributed file system engines, 923 and 933, respectively, for synchronizing a location portion 921 of file system 920 with a remote portion 932 of file system 930 and for synchronizing a location portion 931 of file system 930 with a remote portion 922 of file system 920. As a result of the synchronization, any changes made to local portion 921 of file system 920 are automatically reflected in remote portion 932 of file system 930 and any changes made to local portion 931 of file system 930 are automatically reflected in remote portion 922 of file system 920. In one embodiment, the “local” components 921, 931 of the file systems are those components which are created, edited and/or otherwise accessed locally by the respective virtual data center 910, 911. In contrast, the “remote” components are those which are created, edited and/or otherwise accessed from a different virtual data center 910, 911.

In one embodiment, the distributed file system engines 923, 933 are Hadoop Distributed File System (HDFS) engines and the local and remote portions are implemented as Hadoop nodes. HDFS is a distributed, scalable, and portable file-system which stores large files across multiple machines and achieves reliability by replicating the data across multiple hosts. As a result Hadoop instances do not require RSID storage on hosts. Data nodes can talk to each other to rebalance data, move copies around, and maintain a high replication of data. In the implementation shown in FIG. 9, the Hadoop protocol may be used to synchronize the local 921 and 931 and remote 932 and 922 portions, respectively, of the file systems 920, 930. It should be noted, however, that the underlying principles of the invention are not limited to any particular distributed file system protocol.

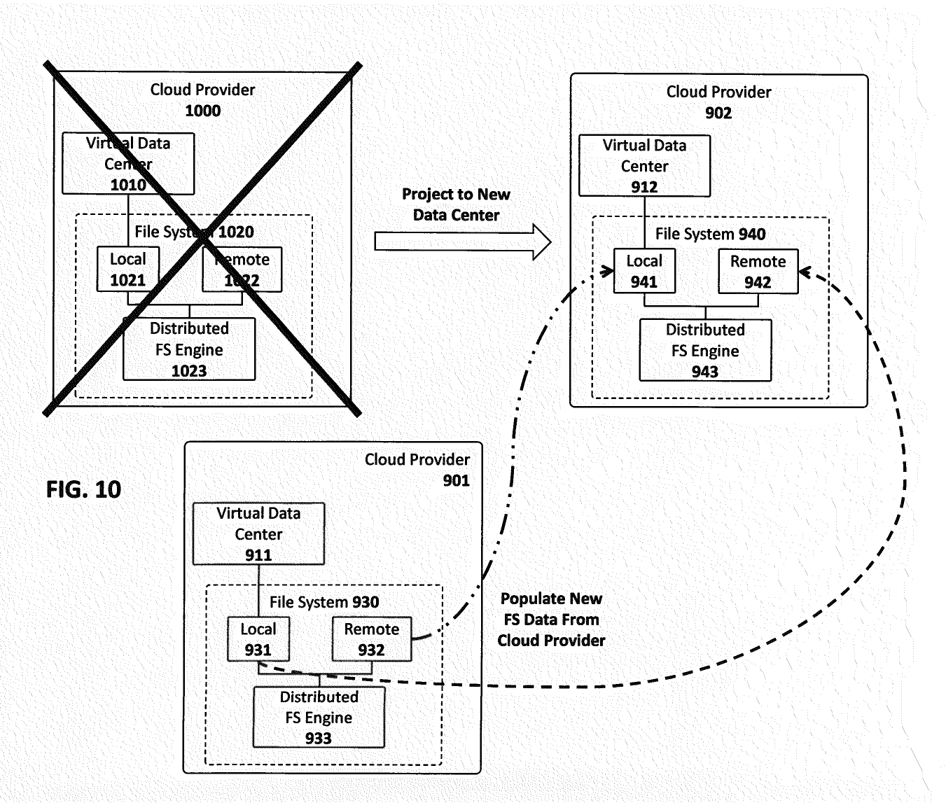

In one embodiment of the invention, a distributed file system (such as described above) is used to streamline the data center migration process. For example, as illustrated in FIG. 10, if the user chooses to migrate from cloud provider 900 to a new cloud provider 902, then once the new projection is complete (e.g., using the virtual data center techniques described herein), the underlying file system 940 for the virtual data center 912 may be populated using the protocol of the distributed file system engine 943. For example, in FIG. 10, the local portion 941 of the file system 940 may be populated from the remote portion 932 of the existing file system 930 of cloud provider 901. Similarly, the remote portion 942 of the file system 940 may be populated from the local portion 931 of the existing file system 930 of cloud provider 901. In one embodiment, the entire contents of the local 941 and remote 942 portions of file system 940 do not need to be completely populated before the cloud provider 902 is put online. Rather, the local 941 and remote 942 distributed file system nodes may be created and populated during runtime (after the virtual data center 912 is placed online). When a request for data is received at local node 941 or remote node 942, which is not available locally, the data may be retrieved from remote node 932 or 931 respectively, thereby populating the local node 941 and remote node 942 during runtime. As a result, the virtual data center 912 may be spun up on cloud provider 902 much more efficiently than in prior implementations (i.e., where all of the file system 940 data is required in advance).

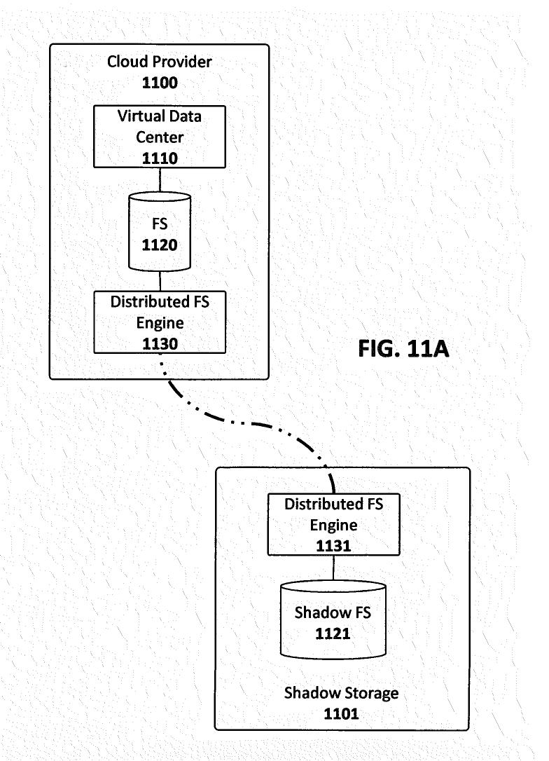

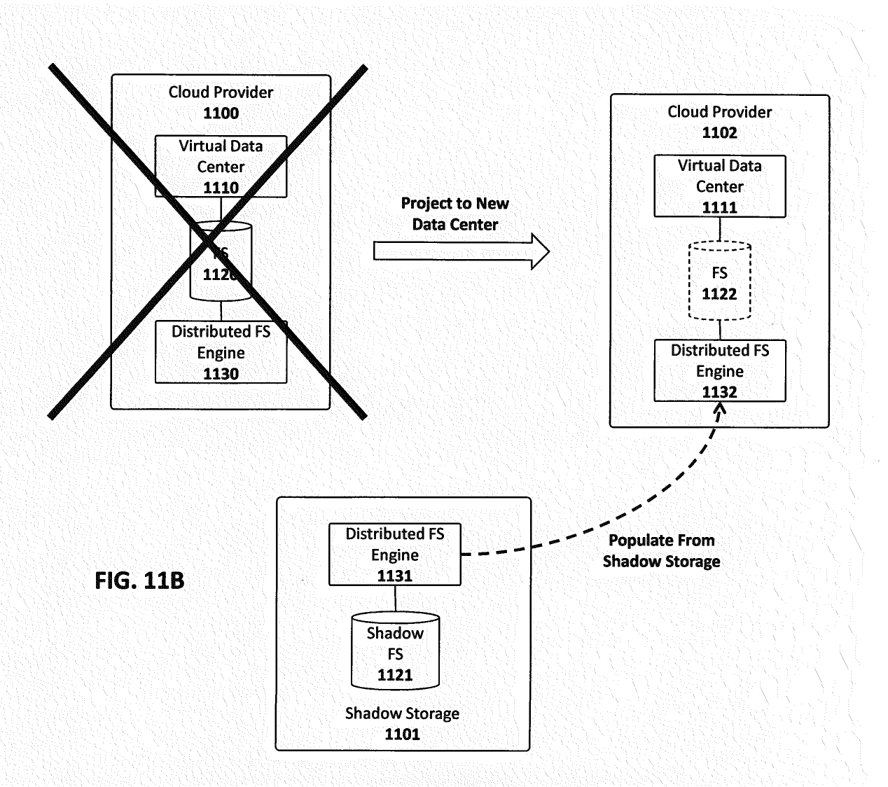

FIG. 11A illustrates another embodiment which includes a could provider 1100 is running a virtual data center 1110 coupled to a file system 1120 managed by a distributed file system engine 1130 (as in the prior embodiment). In this embodiment, a shadow storage system 1101 is used for storing a shadow copy 1121 of the virtual data center file system 1120. A distributed file system engine 1131 communicatively coupled to the distributed file system engine 1130 of the virtual data center is configured to maintain a synchronized, shadow copy 1121 of file system 1120. In one embodiment, as changes are made to the local file system 1120, the distributed file system engines 1130-1131 coordinate to reflect those changes in the shadow file system 1121. The difference in this embodiment is that the shadow storage 1101 is not itself a data center accessible by end users. Rather, it is used only for shadow storage.

In one embodiment, the shadow storage system 1101 is used to streamline the data center migration process. For example, as illustrated in FIG. 11B, if the user chooses to migrate from cloud provider 1100 to a new cloud provider 1102, then once the new projection is complete (e.g., using the virtual data center techniques described herein), the underlying file system 1122 for the virtual data center 1111 may be populated using the protocol of the distributed file system engine 1132. For example, in FIG. 11B, file system 1122 may be populated from the shadow copy of the file system 1121 stored on the shadow storage system 1101.

As in the embodiments described above, the entire contents of the file system 1121 need not be completely populated to file system 1122 before the cloud provider 1102 is placed online. Rather, the distributed file system node 1122 may be created and populated during runtime (after the virtual data center 1111 is placed online). When a request for data is received at the file system 1122 which is not available locally, the data may be retrieved from the shadow file system 1121, thereby populating the file system 1122 during runtime. As a result, the virtual data center 1111 may be spun up on cloud provider 1102 much more efficiently than in prior implementations.

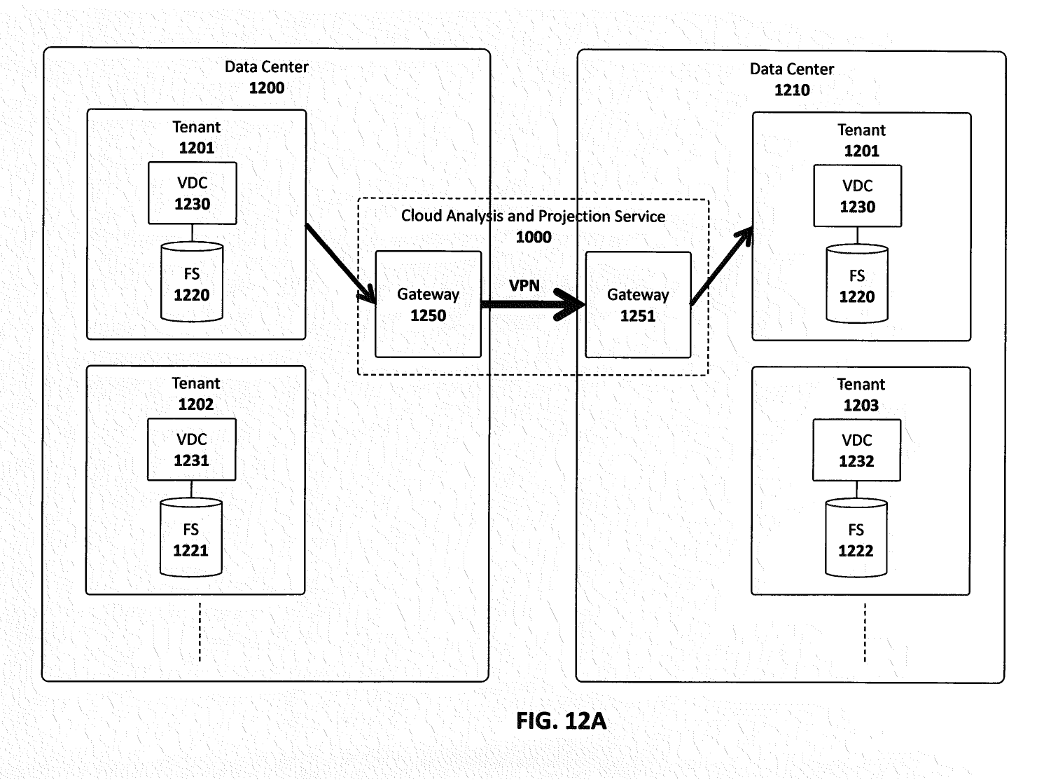

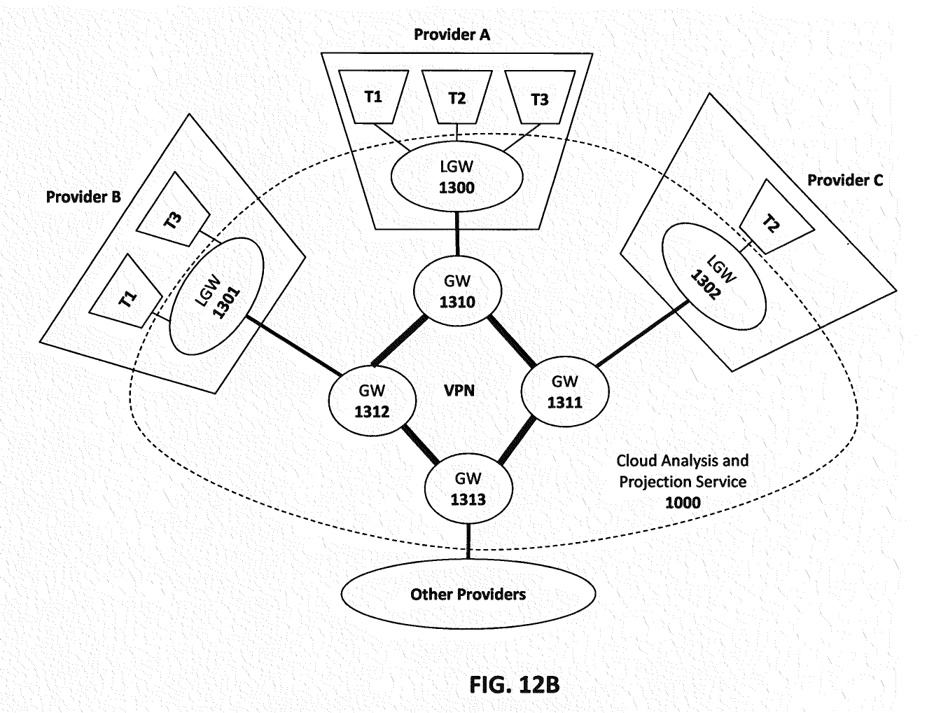

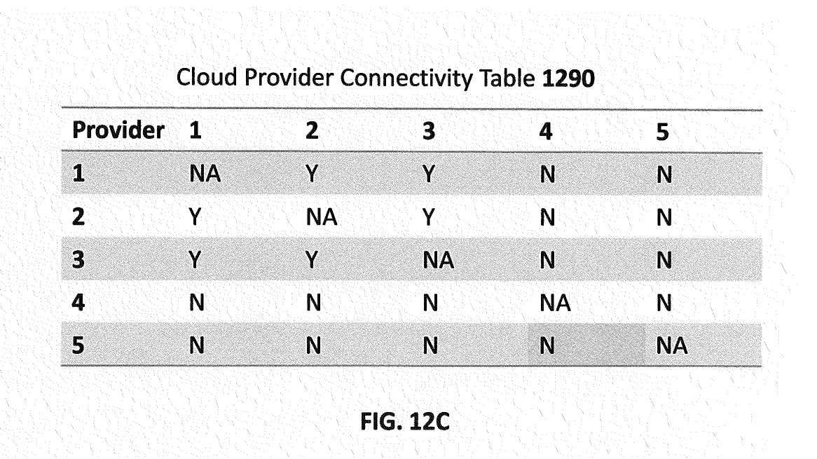

As illustrated in FIG. 12A, in one embodiment, the cloud analysis and projection service 1000 may be implemented using its own gateway devices, 1250 and 1251, at different data centers 1200 and 1210, respectively. The gateways 1250 may then be used to establish a secure connection such as a virtual private network (VPN) connection between the data centers when performing intra-data center migrations. In one embodiment, the VPN connection comprises a purchased WAN accelerator link such as those which provide deduplication compression algorithms (e.g., Riverbed).

Two tenants are illustrated in data center 1200: tenant 1201 with virtual data center 1230 and file system 1220 and tenant 1202 with virtual data center 1231 and file system 1221. An additional tenant 1203 with virtual data center 1232 and file system 1222 is located within data center 1210. As used herein, the “tenants” are cloud users who have signed up for the virtual data center services described herein. In the illustrated example, the dedicated VPN connection is used to migrate the virtual data center 1230 of tenant 1201 from data center 1200 to data center 1210. In this case, because the VPN connection is a dedicated link between the data centers (purchased by the CAPS 100), no additional cost is incurred by the tenant 1201 for the data center migration.

As illustrated in FIG. 12B, in one embodiment, in addition to providing local gateway devices 1300-1302 at each of the cloud providers A-C, the cloud analysis and projection service 1000 may build/purchase a network fabric (e.g., a dedicated network infrastructure/backbone, etc) comprising additional gateway/router devices 1310-1313 to support high speed, secure interconnections between the various providers.

In one embodiment, the cloud analysis and projection service 1000 maintains a provider connection table 1290 such as shown in FIG. 12C to determine whether a dedicated, high speed connection exists between the data centers of any two cloud providers. In the particular example shown in FIG. 12C, providers 1-3 are all interconnected via a dedicated network infrastructure (e.g., maintained/purchased by the CAPS 100) whereas no such connection exists to cloud providers 4 and 5. In one embodiment, the cloud analysis and projection service 1000 and/or selection engines 220-222 may consult the table 1290 when rendering data center recommendations or selections. For example, if data centers 3 and 5 have similar cost, performance, and reliability characteristics but data center 3 is coupled to the current data center via a dedicated, high speed connection, then the selection engine may recommend migrating to data center 3 above data center 5.

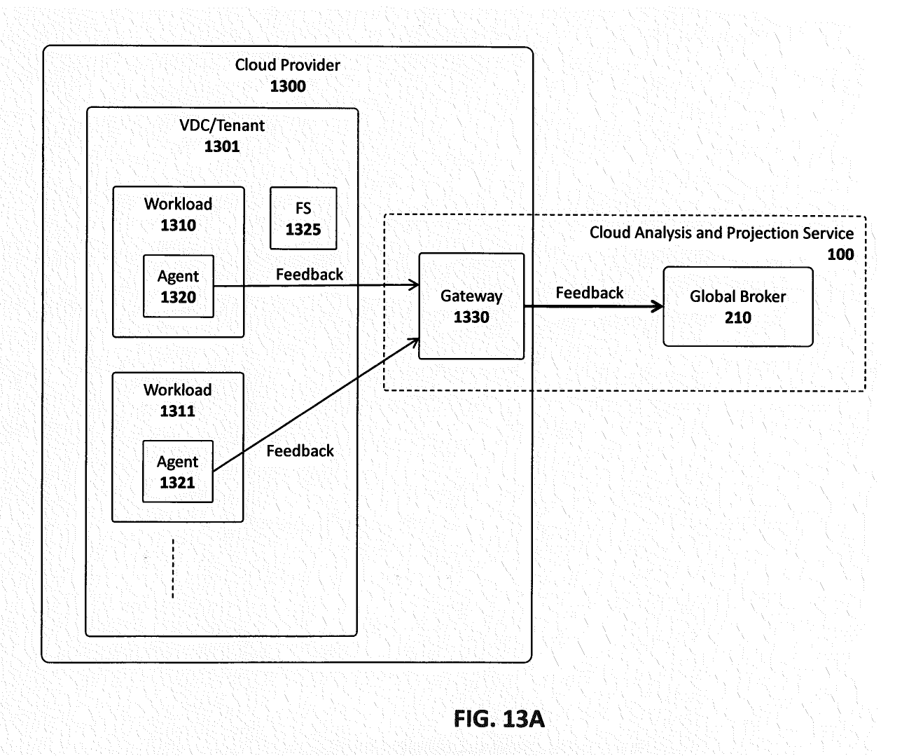

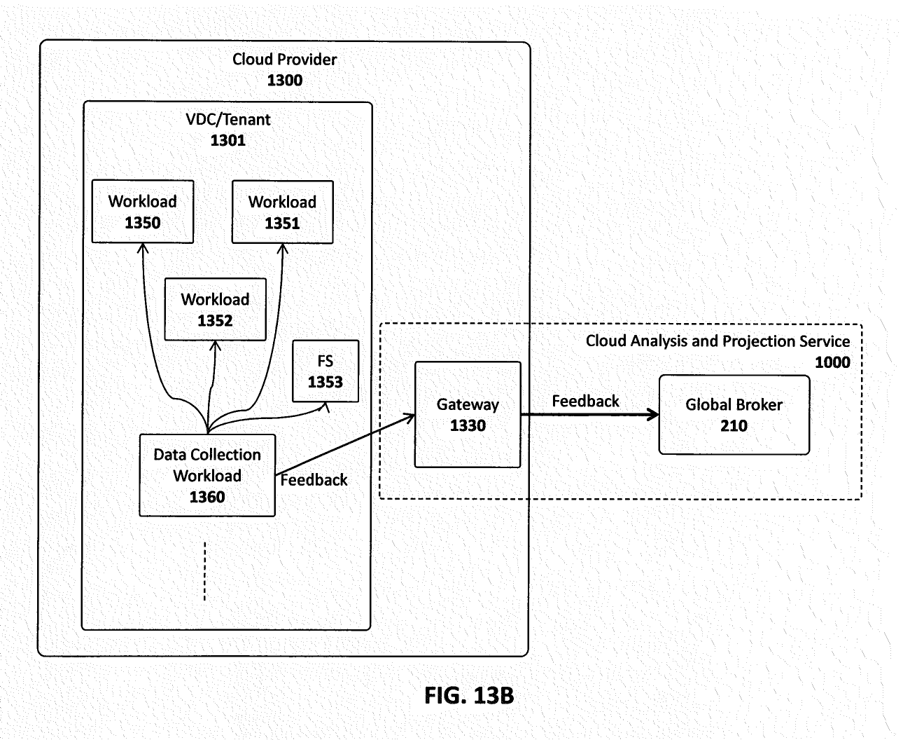

As mentioned above, the Global Broker 210 may be updated dynamically by feedback from the cloud providers which may include cost, performance and/or reliability updates. FIG. 13A illustrates one embodiment in which performance and/or reliability updates are dynamically provided by agents 1320-1321 executed within the virtual data center 1301 for a particular tenant. In this particular embodiment, an agent 1320-1321 is inserted into each workload 1310-1311, respectively, being executed on the resources of the virtual data center 1301. The agents 1320-1321 monitor the execution of their respective workloads 1310-1311 and collect performance data. For example, the agents 1320-1321 may measure the time required to complete execution of program code by the workloads 1310-1311 and/or may ping other components within the virtual data center (e.g., the file system 1325) and measure the time taken to receive a response from each component. This information may then be reported back to the global broker 210 via a gateway 1330 and used to calculate a normalized performance measurement for the cloud provider 1300.

FIG. 13B illustrates another embodiment in which a separate data collection workload 1360 is executed in parallel with the other workloads 1350-1352 within the virtual data center 1301 to collect performance and/or reliability data. The data collection workload 1360 may ping the other workloads 1350-1352 and other data center components such as the file system 1353 and measure the amount of time taken to receive a response (with longer time periods indicating relatively lower performance). The data collection workload 1360 may also calculate the amount of time required to execute its own program code (e.g., inserting tags in the program code or performing other program tracing techniques). Because it is executed as another workload on the resources of the cloud provider 1300, the performance associated with its own execution is indicative of the performance of the other workloads 1350-1352. It may then feed back the performance results to the global broker 210 via the gateway 1330.

In another embodiment, the gateway 1330 itself may collect performance data from the workloads 1350-1352 (e.g., pinging the workloads as described above) and feed the resulting data back to the global broker 210.

In both of the embodiments shown in FIGS. 13A-B, the agents 1320-1321 or data collection workload 1360 may also monitor the reliability of the virtual data center. For example, if a response to a ping is not received after a specified period of time, then a determination may be made that the component being measured has become unavailable. This reliability information may then be transmitted to the global broker 210 via the gateway 1330.

As mentioned above, in one embodiment, the CAPS 100 architecture may be used as an online marketplace for buying and selling data center services may be built using the CAPS 100 architecture. Moreover, the marketplace is not limited to buying by cloud users and selling by actual cloud providers. Rather, in one embodiment, any user or entity may buy and sell data center services in the open marketplace. Thus, a particular cloud provider may purchase data center services from another cloud provider (including a virtual provider as discussed below) to meet demand. Conversely, a cloud user may sell data center services to another cloud user or to another cloud provider. For example, a particular cloud provider may offer a sale on data center services several months in advance of anticipated usage of the data center services (e.g., selling in June for data center usage in December/January). Using the open marketplace provided by the CAPS 100 another user or cloud provider may purchase these services and subsequently re-sell them (e.g., at a premium or a loss, depending on the going rate for the services in December/January). In this manner, a futures market for data center services is established by the CAPS 100.

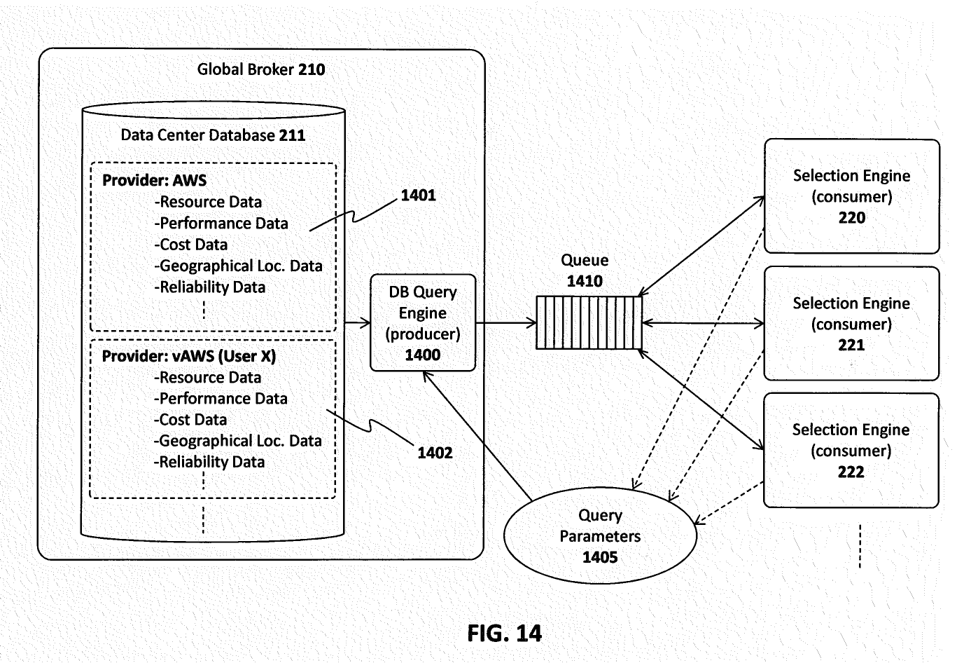

FIG. 14 illustrates how the global broker 210 and data center database 211 may be configured to enable such an online marketplace. As previously mentioned, the data center database 211 contains up-do-date records for each of the cloud providers registered with the CAPS 100 which include resource data, performance data, cost data, geographical location data, reliability data, and any other data which may be pertinent to a cloud user. Record 1401 is associated with and includes all of the current information for Amazon Web Services (AWS). In contrast, record 1402 represents a user (or another cloud provider) who has purchased AWS data center services at a particular price for some specified period of time (identified as a virtual AWS (vAWS) database record). Returning to the example mentioned above, this user may have purchased data center services from AWS for December/January several months in advance but does not intend to use these data center services (or perhaps purchased with the intent of using only a portion, or realized some time after purchasing that he/she would not require all of the purchased services). In one embodiment, any user who has purchased future (or current) rights to data center services may register the availability of these services within the data center database 211 of global broker 210. The global broker 210 may then include these services in response to database queries generated from the various selection engines 220-222. If the cost of these services is lower than the current market price (all other things being equal), then the selection engines 220-222 will recommend/select these services over those offered at the current market price (thereby resulting in a profit to the seller, assuming that the seller purchased at a lower price).

FIG. 14 illustrates additional details associated with the communication between the selection engines and the global broker 210. In particular, query parameters 1405 may be sent from each of the selection engines 220-222 to a database query engine 1400 which then queries the data center database 211 using the parameters. For example, selection engine 220 may be interested in data centers located in New York and Japan; selection engine 221 may be interested in data centers located in California; and selection engine 222 may be interested in data centers located in Europe. In response, the database query engine may perform a query (or a series of queries) and retrieve from the database 211 all data centers meeting the specified criteria. In one embodiment, the results are the “candidate” data centers mentioned above (i.e., those meeting some minimum initial criteria; in this case based on geographic location).

In one embodiment, the results of the database query engine 1400 are provided as entries in a queue 1410 and each of the selection engines read/filter the entries from the queue 1410. In one embodiment, a producer/consumer architecture is implemented in which the database query engine 1400 acts as a producer (writing new entries to the queue) and the selection engines 220-222 act as consumers of the queue (also sometimes referred to as “listeners” to the queue). Returning to the above example, selection engine 220 will only retrieve those entries from the queue 1410 associated with data centers in New York and Japan; selection engine 221 will only retrieve those entries from the queue 1410 associated with data centers in California; and selection engine 222 will only retrieve those entries from the queue 1410 associated with data centers in Europe. The various selection engines 220-222 may then perform filtering/weighting operations as discussed above, to further filter the candidate data centers to arrive at recommendations or selections on behalf of the cloud user (e.g., filtering based on cost, performance, reliability, etc). Although not explicitly shown in FIG. 14, each selection engine may generate queries over the queue to retrieve only those entries which are relevant to its search (e.g., New York and Japan for selection engine 220).

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable program code. The machine-readable medium may include, but is not limited to, floppy diskettes, optical disks, CD-ROMs, and magneto-optical disks, ROMs, RAMs, EPROMs, EEPROMs, magnetic or optical cards, or other type of media/machine-readable medium suitable for storing electronic program code.

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules and methods described herein may be implemented as software, hardware or any combination thereof. Moreover, although some embodiments of the invention are described herein within the context of a mobile computing environment, the underlying principles of the invention are not limited to a mobile computing implementation. Virtually any type of client or peer data processing devices may be used in some embodiments including, for example, desktop or workstation computers. Accordingly, the scope and spirit of the invention should be judged in terms of the claims which follow.

We claim:

1. An apparatus comprising:
a graphical user interface (GUI) comprising a plurality of objects selectable and editable by an end user;
a virtual device controller layer comprising a plurality of virtual device controllers, each virtual device controller representing a physical data center resource and its associated configuration, the combined plurality of virtual device controllers forming a virtual data center;
wherein each of a plurality of the objects of the GUI represent and map to a particular virtual device controller within a virtual device controller layer; and
wherein a user may edit data center resources and the associated configuration of the data center resources by selecting the objects associated with the virtual device controllers of those resources.

2. The apparatus as in claim 1 wherein the physical data center resources comprise virtual machine platforms.

3. The apparatus as in claim 1 wherein at least some of the virtual device controllers represent virtual storage resources.

4. The apparatus as in claim 1 wherein at least some of the virtual device controllers represent virtual networking resources.

5. The apparatus as in claim 1 wherein at least some of the virtual device controllers represent virtual processing resources.

6. The apparatus as in claim 1 further comprising a separate plugin module to map and/or translate each virtual device controller into a format capable of being implemented on the resources provided by the physical data center.

7. The apparatus as in claim 1 wherein at least one of the virtual device controllers represents a network router responsible for routing between subnetworks within the datacenter.

8. The apparatus as in claim 1 wherein the objects are graphically arranged to represent a hierarchical relationship between the objects within the virtual data center and wherein the user may edit the hierarchical relationships by selecting and dragging the objects.
